(19) United States
(12) Patent Application Publication
(10) Pub. No.: US 2019/0231647 A1
(43) Pub. Date: Aug. 1, 2019

(54) ENTERAL FEEDING TUBE WITH INFLATABLE CUFF

(71) Applicants: HAMAD MEDICAL CORPORATION, Doha (QA); HAMAD MEDICAL CORPORATION GLOBAL PATENT TRUST, Alexandria, VA (US)

(72) Inventor: YASSER SHOUMAN, DOHA (QA)

(73) Assignee: HAMAD MEDICAL CORPORATION, DOHA (QA)

(21) Appl. No.: 16/314,811

(22) PCT Filed: Jul. 6, 2017
(86) PCT No.: PCT/US2017/040896

§ 371 Date: Jan. 2, 2019

Related U.S. Application Data
(60) Provisional application No. 62/359,185, filed on Jul. 6, 2016.

(51) Int. Cl. A61J 15/00

(52) U.S. Cl. CPC A61J 15/0049; A61J 15/0073; A61J 15/0003

(57) ABSTRACT

The enteral feeding tube (100) with an inflatable cuff includes a mother tube (110) having a proximal end (112a) and an opposing distal end (112b) and a lumen extending therebetween, an inflatable cuff (115) disposed at the distal end (112a) of the mother tube (110), and a secondary tube (120) having a proximal end (122a) and an opposing distal end (112b) and a lumen extending therebetween. The enteral feeding tube (110) can be inserted into a patient's intestine through the mouth or nose of the patient. The inflatable cuff (115) can be inflated to engage and seal the pylorus of the patient's stomach, so that the distal end (122b) of the secondary tube (120) may extend into the jejunum to permit delivery of food thereto.

### TECHNICAL FIELD

The present invention relates to medical feeding tubes, and particularly to a post-pyloric feeding tube configured for passing beyond the pyloric region of the stomach and into the intestines.

### BACKGROUND ART

Patients who cannot feed themselves through their mouth due to certain conditions and/or illnesses need to be fed to support and provide energy to the various other bodily systems. While early feeding via the gastrointestinal tract has the advantage of decreasing the incidence of sepsis, there are various complications associated with feeding critically ill patients, or those who have undergone significant abdominal operations, in this manner. For example, patients who are critically ill are usually not well enough to carry on the function of swallowing.

The solution to this problem is to pass a plastic tube through the mouth or nose [usually through the nose, as it is more tolerable, stable, and less subject to damage] to end in the stomach, which will be the food receiver. The stomach in critically ill patients and after operations involving the abdominal cavity is notoriously static, and hence does not pass the food on to the next segment of the gastrointestinal tract (GIT). The result of that is gastric dilatation and reflux, which increases the incidence of regurgitation and aspiration into the lungs. The well-known consequences of gastric dilatation and reflux are respiratory infection and the development of acute lung injury due to aspiration of gastric contents.

Currently the methods utilized for feeding critically ill patients involve the use of devices, such as endoscopy to guide and position a postpyloric feeding tube, fluoroscopy tubes, or specially designed tubes, as well as prokinetic drugs. Endoscopy requires considerable expertise and time to prepare, which adds to the time and expense of the overall procedure, making postpyloric feeding by endoscopy a procedure that is only used in certain circumstances. Other methods utilized for feeding critically ill patients are not only unreliable, but have a significantly low success rate.

Thus, an enteral feeding tube with inflatable cuff solving the aforementioned problems is desired.

### DISCLOSURE OF INVENTION

The enteral feeding tube with an inflatable cuff includes a mother tube having a proximal end and an opposing distal end defining a lumen extending therebetween, an inflatable cuff disposed at the distal end of the mother tube, and a secondary tube having a proximal end and an opposing distal end defining a lumen extending therebetween. Feeding will be effective through the secondary tube, and the mother tube will act as a conduit to facilitate the proper postpyloric positioning of the secondary tube. The mother tube can be inserted through a patient's mouth or nose to rest in the stomach. The inflatable cuff can be inflated to engage and seal the pylorus of the patient's stomach, such that the distal end of the secondary tube, by passing through the mother tube, may extend into the jejunum to permit delivery of food thereto. Neither the mother tube nor the secondary tube requires endoscopy for insertion or positioning.

These and other features of the present invention will become readily apparent upon further review of the following specification and drawings.

### BRIEF DESCRIPTION OF THE DRAWINGS

FIG. 1 is a perspective view of an enteral feeding tube with inflatable cuff according to the present invention.

FIG. 2 is a diagrammatic environmental perspective view of the enteral feeding tube of FIG. 1, showing the cuff inflated at the pylorus to secure the mother tube while the secondary tube extends into the intestine.

Similar reference characters denote corresponding features consistently throughout the attached drawings.

### BEST MODE(S) FOR CARRYING OUT THE INVENTION

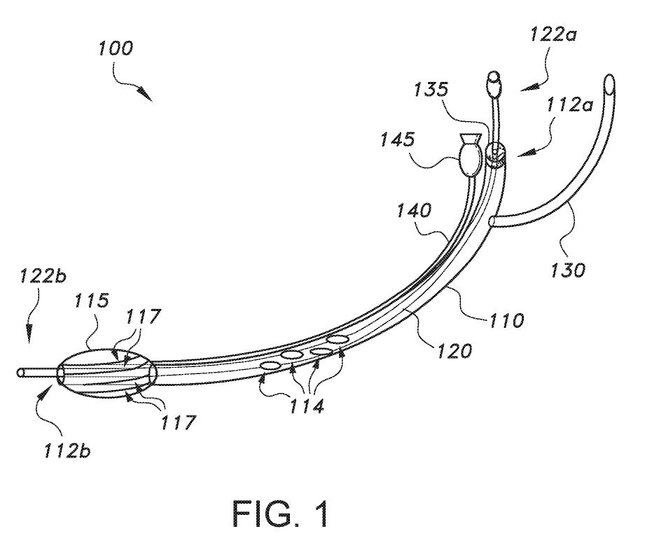

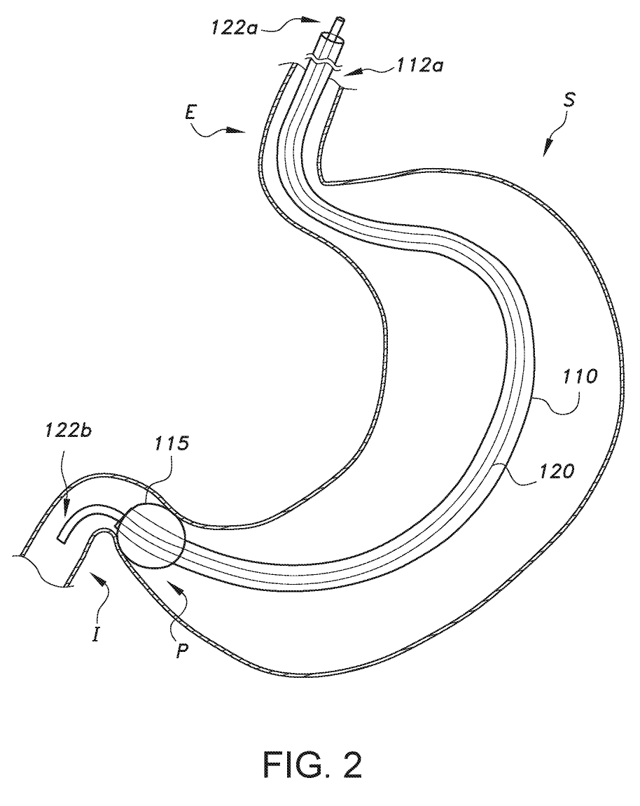

Referring to FIGS. 1 and 2, the enteral feeding tube with inflatable cuff, designated generally as 100 in the drawings, includes a mother tube 110 having a proximal end 112a and an opposing distal end 112b defining a lumen extending therebetween. The proximal end 112a of the mother tube 110 is adapted for positioning external to an esophagus of a patient and coming out of the nose or mouth of the patient, whereas the opposing distal end 112b of the mother tube 110 is adapted for positioning at the pylorus P of the stomach S of the patient. An inflatable cuff 115 is disposed at the distal end 112b of the mother tube 110. The enteral feeding tube 100 also includes a secondary tube 120 slidably extendable in the mother tube 110, the secondary tube 120 having a proximal end 122a and an opposing distal end 122b defining a lumen extending therebetween. The proximal end 122a of the secondary tube 120 is adapted for extending out of the nose or mouth of the patient, whereas the opposing distal end 122b of the secondary tube 120 is adapted for sliding through the duodenum and positioning in the jejunum of the patient when the cuff 115 is inflated. The inflatable cuff 115 engages and seals the pylorus P of the patient such that the distal end 122b of the secondary tube 120 may extend into the intestine I, and once positioned, the cuff is deflated to stabilize the mother tube 110 in the stomach.

The mother tube 110 can be formed from any suitable medical grade material, such as a medical grade plastic. The mother tube 110 is an elongate, flexible tubular structure that may be made of semi-soft material, preferably a material that softens on heat exposure (in this case, the range of body temperature). While the mother tube 110 can vary in length and in diameter, representative or exemplary dimensions include an internal diameter of 5-6 mm and a length of 50-60 cm, marked or graduated by indicia every 5 cm. The proximal end 112a of the mother tube 110 has two ports, one for passing the secondary tube 120 through the lumen of the mother tube, the other port having a pilot balloon connected to an inflation tube used to inflate the cuff. The distal 15 cm would be curved at an arbitrary angle of curvature, e.g., 45°. There would be a corresponding mark in the same direction of the curvature at the proximal end 112a of the mother tube 110 to allow directing the tip of the tube 110 towards the pylorus by manipulating the proximal end 112a. A metal ring may be incorporated in the very distal end 112b to facilitate X-ray identification, should it be required. The mother tube 110 has four orifices 114 (0.25 to 0.5 cm² in surface area) defined therein about 5 cm above the proximal end of the balloon for drainage of fluids from the stomach. A drainage tube 130 is attached to the mother tube 110, as shown in FIG. 1, and attached to a suction pump to complete drainage of fluids from the stomach before inserting the secondary tube 120 or if decompression of the stomach is needed.

Similarly, the secondary tube 120 can be formed by any suitable biocompatible material, such as medical grade plastic. Preferably, the secondary tube 120 is an elongate, flexible tubular structure having a length greater than the mother tube and a diameter smaller than the mother tube 110, being dimensioned and configured to extend outside the proximal end 112a of the mother tube 110, through the mother tube 110 and out the distal end 112b through the pylorus and duodenum into the jejunum, and to deliver nutrition into the intestine. The secondary tube 120 would have a guide wire in its lumen (as normally happens when used on its own) to facilitate manipulation and visualization on the x-ray pictures to confirm its position. An example of a secondary tube 120 that can be used in the enteral feeding tube 100 is the size 6 French Corflo tube (©CORPAK MedSystems). The secondary tube 120 may include an occlusion member 135, which may be a disc-type occlusion member, disposed at the proximal end 122a of the secondary tube 120. The occlusion member 135 may be expanded to cover the proximal end 112a of the mother tube 110 and prevent any discharge through the proximal end 112a of the mother tube 110.

The inflatable cuff 115 disposed at the distal end 112b of the mother tube 110 may be formed from any suitable, strong, puncture-resistant medical grade material, such as polyethylene terephthalate (PET), nylon, polyurethane, and other elastomers. Further, the inflatable cuff 115 can be attached to the mother tube 110 by any type of suitable adhesive, such as UV adhesive. The inflatable cuff 115 can also be adapted to expand to a specific size, such as the size of the opening of the pylorus P of the stomach S. The inflatable cuff 115 may be produced in a wide range of diameters, lengths, and shapes, such as conical, spherical, square, stepped, tapered, and offset. It is desirable, however, that the inflatable cuff 115 has a fusiform shape (e.g., similar to the shape of a football or rugby ball) adapted to secure the position of the distal end 112b of the mother tube 110 against the opening of the pylorus P and allow the secondary tube 120 to pass into the jejunum. The inflatable cuff 115 may also be coated for lubrication or for abrasion resistance.

Further, the enteral feeding tube 110 may include an inflation port 140, such as extending from the mother tube 110 adjacent to the proximal end 112a of the mother tube 110 to inflate the inflatable cuff 115. A pilot balloon 145 may be positioned in fluid communication with the inflatable cuff 115, the pilot balloon 145 being mounted on the inflation port 140 adjacent the proximal end thereof. Further, the inflatable cuff 115 can include a plurality of grooves 117, such as spiral grooves, configured to produce an easily gliding fit between the inflatable cuff 115 and the interior lining of the pylorus P.

By way of operation, the mother tube 110 would be inserted through the nose using whatever method the clinician uses to insert an ordinary naso-gastric tube. Once the mother tube 110 is in the esophagus (usually indicated by the smooth advancement of the tube or under vision if a laryngoscope is used), the direction of the curvature is adjusted aided by the mark on the proximal end 112a of the mother tube 110 to face the right side of the patient. When the 30-40 cm mark is reached (as noted above, the mother tube 110 is preferably marked every 5 cm in length), checking of the position in the stomach is done by checking the pH of the stomach aspirate. If still in doubt x-ray film might be necessary.

After the distal end 112b is confirmed to be in the stomach and the stomach is emptied by aspiration or suctioning, inflation of the balloon is next and advancing the mother tube 110 until a resistance is felt. In this position the distal end 112b is expected to be snugly facing the pylorus, and the balloon is occupying the pyloric antrum. At this point the position of the tube 110 is maintained and threading the secondary tube 120 is next.

As the distal end 112b of the mother tube 110 is facing the pylorus and because of the short distance between each other and the stability provided by the balloon in the antrum, the chances of the secondary tube 120 finding the pylorus are expected to be much higher than with the completely blindly inserted tubes. Also, because the mucosal folds of the stomach are longitudinal, and the conical configuration of the pyloric antrum in the direction of advancement of the secondary tube 120, and the presence of the mucous lining of the stomach, the sliding of the secondary tube 120 would be expected to be easy.

After passing the secondary tube 120 to the length of the mother tube 110, a further 30 cm advancement of the secondary tube 120 is required to rest the distal end 122b of the secondary tube 120 in the jejunum. An x ray picture would then be taken with the guide wire in situ, and if the position is verified, the balloon would be deflated and the mother tube 110 would be left in place to drain the stomach when needed. The advancement of the distal end of the mother tube 110 may be monitored by ultrasound scanning or by the incorporation of a light at the end, which would show through the abdominal wall. Making slight angulations at the tip of the secondary tube 120 by slightly bending the guide wire will enable the tip of the tube 120 maneuver in different areas and hit different spots, hence increasing the chance to find the pyloric opening to pass through.

It is to be understood that the present invention is not limited to the embodiments described above, but encompasses any and all embodiments within the scope of the following claims.

I claim:

1. An enteral feeding tube with an inflatable cuff, comprising:
a mother tube having a proximal end and an opposing distal end, and a lumen extending therebetween, the proximal end being adapted for positioning external to a nose and mouth of a patient, the distal end thereof being adapted for positioning at the pylorus of the patient;
an inflatable cuff disposed at the distal end of the mother tube; and
a secondary tube extending through the mother tube, the secondary tube having a proximal end and an opposing distal end defining a lumen extending therebetween, the proximal end being adapted to extend out of the mother tube at the nose or mouth of the patient, and the distal end being adapted for positioning in the jejunum of the patient;
wherein when the inflatable cuff is inflatable to engage and seal the pylorus of the patient so that the distal end of the secondary tube extends into the intestine for delivery of food thereto through the secondary tube.

2. The enteral feeding tube according to claim 1, wherein the distal end of the mother tube is arcuate.

3. The enteral feeding tube according to claim 1, further comprising a pilot balloon in fluid communication with the inflatable cuff, the pilot balloon being mounted on the mother tube adjacent the proximal end thereof.

4. The enteral feeding tube according to claim 1, wherein the mother tube has a length between 50 cm and 60 cm.

5. The enteral feeding tube according to claim 1, wherein the secondary tube further includes an occlusion member disposed at the proximal end thereof.

6. The enteral feeding tube according to claim 1, wherein the inflatable cuff has a plurality of ridges defined therein.

7. The enteral feeding tube according to claim 1, further comprising an inflation port to inflate the inflatable cuff.

8. The enteral feeding tube according to claim 1, wherein the mother tube has a plurality of drainage holes defined therein, the enteral feeding tube further comprising a drainage tube extending from the proximal end of the mother tube, whereby fluids may be drained from the patient's stomach through the mother tube.

9. The enteral feeding tube according to claim 1, wherein the mother tube has two ports at the proximal end of the mother tube, including a first port for passage of said secondary tube through the lumen of the mother tube and a second port for inflation of said inflatable cuff.
